(19) United States
(12) Patent Application Publication
(10) Pub. No.: US 2008/0028420 A1
(43) Pub. Date: Jan. 31, 2008

(54) Optical Media with Reduced Areal-Sized Optical shutters

(76) Inventors: Paul Atkinson, Poway, CA (US); John H. Rilum, Tustin, CA (US)

Correspondence Address: WILLIAM J. KOLEGRAFF;KESTREL WIRELESS, INC., 15050 AVENUE OF SCIENCE, STE. 230, SAN DIEGO, CA, 92128, US

(21) Appl. No.: 11/625,566

(22) Filed: Jan. 22, 2007

Related U.S. Application Data
(60) Provisional application No. 60/760,825, filed on Jan. 20, 2006.

(51) Int. Cl. G11B 7/24

(52) U.S. Cl. 720/718; 720/658

(57) ABSTRACT

An optical medium incorporates an optical shutter of limited area for controlling access to information contained in the medium. Also disclosed are a system and method for using the optical medium. In one variation, the optical medium incorporates plural optical shutters for selectively permitting access to partitioned portions of the information.

### RELATED APPLICATIONS

This application claims priority to U.S. patent application No. 60/760,825, filed Jan. 20, 2006, and entitled “Optical Media with Reduced Areal-Sized Optical Shutters”, and is related to U.S. application Ser. No. 10/876,642, filed Jun. 23, 2004, for “Method and Apparatus for Activating Optical Media”; and to U.S. application Ser. No. 10/632,047, filed Jul. 31, 2003, for “Wireless Activation System and Method”; all of which are incorporated herein in their entirety.

### FIELD OF THE INVENTION

The present invention relates to a system and method for integrating a switchable optical device, referred to herein as an optical shutter, to an optical medium having at least a single information layer. Additionally, the present invention includes a system and method to selectively control access to various partitioned information on an optical medium by employing multiple optical shutters.

### BACKGROUND OF THE INVENTION

Optical shutters affect the ability of either man or machine to perceive some aspect of the media underlying the shutter by altering the shutter's optical properties. For example, an optical shutter may make media, or a portion thereof, such as a CD, DVD or video game disc readable or non-readable by blocking, reflecting, deflecting, focusing, defocusing, diffusing, refracting, diffracting, wavelength shifting, or otherwise disrupting or interfering with the light source. These optical shutters typically comprise an electronically switchable optical device (e.g. an electrochromic or liquid crystal film) and may be combined with other components such as semiconductors or discrete components (batteries, resistors, gates, switches, antennae etc.) to produce an electronically switchable device that may be communicatively coupled to an external device.

It is often desirable to minimize the size of the optical shutter to, e.g., reduce the manufacturing costs, or, in the case of electrically switchable shutters, to reduce the switching time or required power in order to be able to properly switch the shutter.

### SUMMARY

The present invention is directed to an optical medium, system, and method that meets this need by providing particular combinations of optical shutter elements of limited area in association with enabling content of the optical medium. In one aspect of the invention, an optical medium includes an information layer and an optical shutter for preventing access to only a portion of the content of the information layer. The medium is adapted for holding a first information content not having access preventable by the optical shutter, and a second information content on the information layer, access to the second content being conditionally prevented by the optical shutter. The optical shutter can be electrically switchable and/or one of a plurality of optical shutters that are in different locate

The information layer can be one of a plurality of information layers, the optical shutter being located between the information layers. The optical medium can be configured as an optical disk having first and second information layers, with main content beginning on the first information layer following a lead-in region and potentially extending on the second information layer and followed at a predetermined position by enabling content and a lead-out region on the second information layer, wherein the optical shutter is located for blocking access to the enabling content of the second information layer. In this case, stored fill data extends between an end of the main content and a beginning to the enabling content.

The optical shutter may have a transition region associated therewith, in which case the transition region encompassing only a portion of the information layer that is not required to be accessed.

In another aspect of the invention, a conditional access system includes: (a) a playback device for accessing an optical media having an optical shutter for conditionally blocking access to an enabling content region of the optical medium without blocking access to main content of the medium; (b) means for opening and/or closing the optical shutter with the optical medium being engaged by the playback device; and (c) means for determining authorization for accessing main content associated with the enabling content, the means for opening and/or closing being responsive to the means for determining thereby conditionally permitting access to the enabling content and consequently to the main content portion.

In a further aspect of the invention, a method is provided for conditionally accessing stored main content of an optical medium having an optical shutter for blocking access to an enabling content region of the optical medium without blocking access to the main content. The method includes the steps of:
(a) providing a playback device for accessing the optical media;
(b) determining authorization for accessing main content associated with the enabling content;
(c) opening and/or closing the optical shutter in response to the determined authorization; and
(d) when the optical shutter is open following the determination, accessing the enabling content and consequently the associated main content.

### DRAWINGS

These and other features, aspects, and advantages of the present invention will become better understood with reference to the following description, appended claims, and accompanying drawings, where:

FIG. 1 is a sectional diagram view of an optical medium incorporating an optical shutter according to the present invention;

FIG. 2 is a sectional diagram showing an alternative configuration of the optical medium of FIG. 1;

FIG. 3 is a plan view showing another alternative configuration having filler data located in transition regions of the optical shutter;

FIG. 4 is a sectional diagram showing incorporation of filler data in the configuration of FIG. 2;

FIG. 5 is a block diagram of a system incorporating the optical medium of FIG. 1; and

FIG. 6 is a block diagram of a method for using the system of FIG. 5.

### DESCRIPTION

In the following description, specific details are given to provide a thorough understanding of the embodiments. However, it will be understood by one of ordinary skill in the art that the embodiments may be practiced without these specific details.

The present invention is directed to an optical medium incorporating an optical shutter having limited area for controlling access to data contained in the optical medium. The optical medium can be an optical disc, an optical card, a hologram, or any other optical medium. The medium can retain information permanently, or for a lesser time or planned time of degradation, (e.g., read only medium), be written to once (e.g. write-once medium) or multiple times (e.g. rewritable medium). Furthermore, optical media frequently comprise multiple information or data layers. For example, an optical medium known as DVD-9 contains two information layers, commonly referred to as layer 0 (LO) and layer 1 (L1).

An optical shutter of a desired small size applied to the optical medium may for example only cover a limited area of a single information layer or limited areas of multiple information layers. Depending on the application and means of manufacture the shutter may be incorporated into the optical medium during the manufacturing process of the optical medium or after in a completely separate process. In order to apply such a limited size optical shutter to the optical medium while preserving its functionality of rendering the content non-readable or non-accessible, the present invention provides a novel way of spatially partitioning the content of the optical medium. Furthermore, the present invention also enables an advantageous partitioning scheme in which the physical location of the shutter (in relationship to the optical medium) remains the same even though the accessible content of interest only uses part of the available storage capacity of the optical medium.

With reference to FIG. 1 of the drawings, an exemplary DVD-9 optical medium 10 of opposite track path (OTP) configuration has an LO substrate 12 on which is LO content 14, a lead-in region 16 and a middle region 18 being adjacent opposite extremities of the LO content 14. A spacer layer 20 separates a facing L1 substrate 22 on which is L1 content 24, a lead-out region 26 and a middle region 28. The middle region 28 is opposite the middle region 18, adjacent one extremity of the L1 content 24, the lead-out region 26 being opposite the lead-in region 16. Enabling content 30 (which can be initialization content or “boot up” data) is located adjacent the lead-out region 26, the L1 content 24 reaching only part-way to the enabling content 30. Also shown in FIG. 1 is a conventional playback (laser) device 32, other components of a DVD player being not shown. This exemplary configuration of the optical medium 10 is thus partitioned such that the enabling content 30 is formed in a particular location on the disc. Preferably this location is in the beginning of the lead-out region 26 as shown in FIG. 1, at the beginning of program area, at the end of program area, or at the burst cutting area (BCA) at the inside of the disc. Enabling content can, for example, be the information about the type or format of disc as described by the control data file required in the lead-in area and read by the DVD player, ISO/UDF files describing the file structure for the disc, video file manager, decryption keys, a video file (that would be read prior to displaying a typical navigational menu screen), or a serial number at the burst cutting area.

According to the present invention, an optical shutter element 34 (or optical shutter) is formed between the LO substrate 12 and the L1 substrate 22, for selectively preventing error-free access to a portion of L1 data content, particularly by blocking at least a portion of the enabling content 30. The optical shutter element 34 may be positioned onto the LO information layer of substrate 12 as shown in FIG. 1, onto the enabling content 30 of the L1 information layer of substrate 22, or vertically displaced from these locations within the spacer layer 20. By authoring the disc appropriately the access to the remaining content on the disc can be prevented as long as the enabling content is sufficiently blocked by the optical shutter. The shutter may not need to block the entire enabling content, but can obscure a sufficient portion, either directly by affecting the playback signal or indirectly by affecting the tracking or focusing properties of the playback beam or the electronic servo gain control, the high frequency slicer or equalization performance or other electronic processing, to induce uncorrectable errors.

The location of the enabling content in lead-in or at the beginning of program area is typically well defined allowing for a fixed placement of the shutter independent of content. This is the case for several DVD disc types and formats such as DVD-5, DVD-9 LO, or DVD-9 L1 with parallel track path (PTP) configuration. In case the enabling content is located at the end of program, or at the beginning of program area on a DVD-9 L1 with opposite track path (OTP) configuration, the location is not fixed as it depends on the size of the content (of that particular information layer, or in case of the DVD-9 OTP on the size of the LO information layer as well). In such cases it is advantageous to author (or “layout”) the content including additional “filler” content or “dummy” data in a filler region 36 to ensure the enabling content always occurs at a specific location as shown in FIG. 1. The filler region 36 advantageously allows much simplification during the manufacturing process of shutter equipped optical media. This filler content may, for instance, only contain random data which cannot be accessed through means such as the file structure, file pointers, or navigational menu entries. This approach is particularly desirable for cases in which the optical shutter is located as in the exemplary configuration of FIG. 1, between the LO and L1 information layers on a DVD-9 OTP, thus allowing for placement of the enabling content at a fixed inside radius at the end of program area on L1.

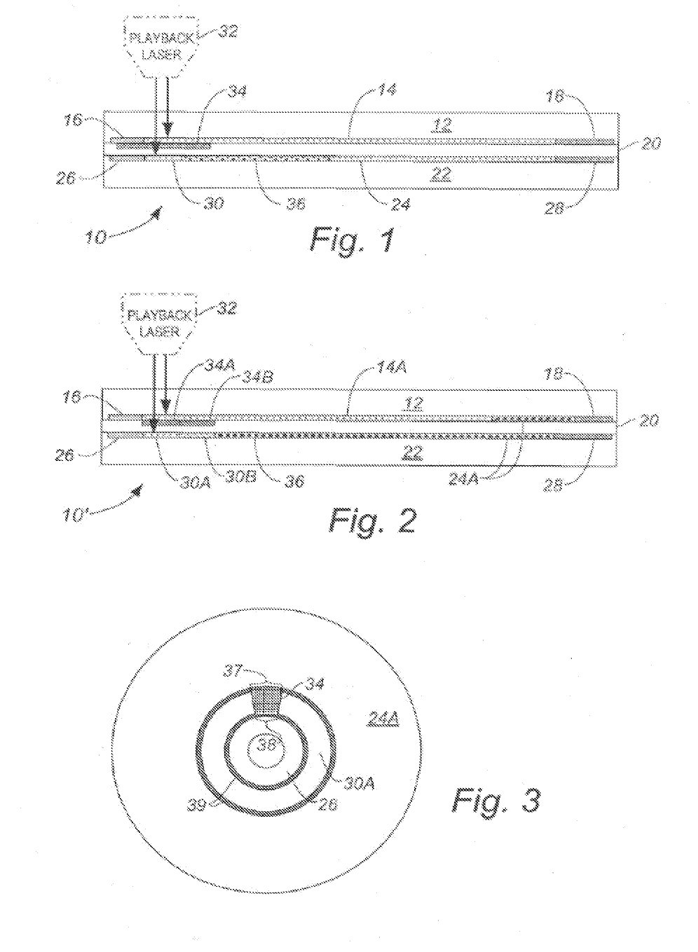

In further accordance with the present invention, multiple limited area optical shutters can be applied to an optical medium having one or more information layers to control access to selected content. It is often desirable to allow end user access to only selected parts of the stored content on an optical medium. For example, on an optical disc in which the content is partitioned into distinct feature sets, such as software applications or modules, or main video and bonus video materials, it may be desirable to only enable or disable one or several of these sets. Preferably the feature sets are spatially partitioned within a single information layer or across multiple layers in order to define physically distinct areas. The optical shutters controlling access to these partitioned feature sets can cover the entire respective area or, as discussed above, only cover the respective enabling initialization content in order to control access to the corresponding area. In the latter configuration there may be a single shutter for each partitioned feature set, or there may be a combination of open/closed shutter configurations which effectively generate a selectable access or decryption key in order to define the desired combinations of access to the partitioned medium. With particular reference to FIG. 2, an alternative configuration of the optical medium, designated 10′, has two optical shutters, designated 34A and 34B, located between the two information layers of a DVD-9 PTP. Each shutter controls the access to respective enabling content 30A and enabling content 30B. By opening the optical shutters 34A or 34B and allowing the playback device 32 to read the enabling content the corresponding main content, either a first main content 14A (in this case located on LO) or a second main content 24A (in this case encompassing both LO and L1) can be accessed. Thus access to either or both of the main contents 14A and 24A can be selectively enabled by the optical shutters 34A and 34B. It will be understood that, when only one content segment at a time is required to be enabled, the optical shutters 34A and 34B can be implemented for selectively enabling any of three content segments, using conventional address logic.

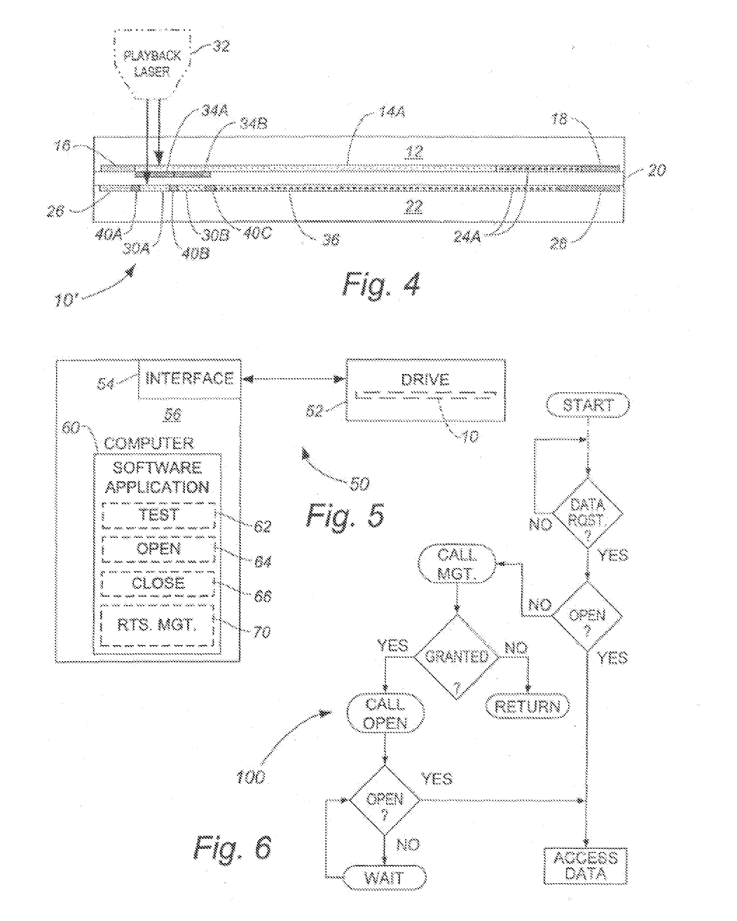

The above access schemes can preferably be implemented by the addition of an access application which verifies the data recovery (for an open shutter region) or lack thereof (for a closed shutter region) and through an imbedded rights management system for granting access to specific feature sets as further described below in connection with FIGS. 5 and 6. In a similar way, as discussed above, if the optical medium is already partitioned in an appropriate manner at the time of manufacture, the access can subsequently be controlled by applying (such as by affixing) the shutter configurations after the optical medium has been manufactured or even sold and returned by an end user.

Whether a single or multiple shutters are incorporated into an optical medium, a limited size shutter which does not fully cover the entire information area normally accessed by a playback device can, depending on the shutter design, even in its open state induce undesirable unrecoverable errors as discussed in Provisional Patent Application Ser. No. 60/703,673 filed Jul. 29, 2005, entitled Devices for Optical Media and incorporated herein by this reference. On an optical disc, such as a DVD-5 or a DVD-9, this is particularly true for optical shutter designs in which the optical characteristics in its open state are sufficiently different from that of the area not covered by the shutter. Additionally, as also discussed in the above-referenced Provisional Patent Application Ser. No. 60/703,673, undesirable unrecoverable errors in the open shutter state can be further exacerbated at the transition regions of the shutter adjacent to non-shuttered areas. As an example, FIG. 3 is a plan view diagramming portions of the optical disc 10, including the second main content 24A, lead-out region 26, enabling content 30A, with the integrated shutter 34. The particular shutter design incorporates transition regions 37 and 38 which are substantially parallel to the concentric tracks on the discs. As the readout device attempts to recover the content or data in this region in the open state of the shutter these transition regions may cause tracking problems subsequently inducing undesired unrecoverable errors in corresponding transition region tracks 39 of the optical medium.

With further reference to FIG. 4, the present invention resolves this matter by including an appropriate amount of filler or “dummy” data as one or more transition filler regions 40 which cannot be accessed through means such as the file structure, file pointers, or navigational menu entries, as discussed above. More particularly in the case of the optical medium 10′ of FIG. 2, a first filler region 40A is provided between the lead-out region 26 and the enabling content 30A, a second filler region 40B is provided between the enabling contents 30A and 30B, and a third filler region is provided between the enabling content 30B and the second main content 24A. Special care in software and player firmware design may need to be undertaken such that the optical playback device does not travel across these filler areas during, e.g., its search sequence to an intended accessible open shutter or non-shutter area.

With further reference to FIGS. 5 and 6, an exemplary conditional access system 50 and method 100 advantageously utilize the optical medium 10 (or 10′). FIG. 5 shows a disk drive unit 52 (which incorporates the playback device 32, not shown) and having the optical disk 10 mounted therein. The drive unit is connected for bidirectional communication to an interface unit 54 of a suitable computer 56 (which can be integrated with the drive unit 52 and which may incorporate player firmware). Access to data stored on the optical medium 10 is controlled by a software application 60. An exemplary implementation of the software application 60 includes a shutter test module 62 for determining whether the optical shutter 34 (or individual shutters 34A and 34B) are open or closed, a shutter open module 64 for selectively opening the shutter(s), a shutter close module 66 for selectively closing the shutters. Also included is an imbedded rights management software 70 that sets up conditions for opening and closing the optical shutter(s).

In the conditional access method 100 of FIG. 6, when a particular data request is made by a user, the associated shutter is tested for an open condition (such as by successfully reading a portion of associated enabling content). If so, control is passed for directly accessing the requested data. If not, the shutter is closed and access will be denied unless authorization can be obtained in a call to the rights management software 70. If granted, the shutter is opened by a call to the shutter open module 64, the software waiting until the open condition is verified, at which point control is passed for accessing the data. If authorization is not granted, the software returns to a main menu module or the like (not shown) for possibly processing a different data request by the user. It will be understood that some data requests can be to data that is subject to authorization expiring, in which case the imbedded rights management software 70 is called initially upon a request for such data and, if the associated optical shutter had been open, the shutter close module 64 would be called to block further access to that data.

Although the present invention has been described inconsiderable detail with reference to certain preferred versions thereof, other versions are possible. For example, the optical shutter and media systems and methods exemplified by DVDs can of course be extended for a variety of optical discs, cards, holograms, or any other optical medium having single of multiple information layers. Therefore, the spirit and scope of the appended claims should not necessarily be limited to the description of the preferred versions contained herein. All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An optical medium comprising:
an information layer and
an optical shutter for preventing access to only a portion of content of the information layer, the medium being adapted for holding a first information content not having access preventable by the optical shutter, and for holding a second information content on the information layer, access to the second content being conditionally prevented by the optical shutter.

2. The optical medium of claim 1 wherein the optical shutter is electrically switchable.

3. The optical medium of claim 1 wherein the optical shutter is one of a plurality of optical shutters, the shutters being in different locations relative to the information layer.

4. The optical medium of claim 3 wherein the optical shutters are individually switchable.

5. The optical medium of claim 1 wherein the information layer is one of a plurality of information layers, the optical shutter being located between the information layers.

6. The optical medium of claim 5 configured as an optical disk having first and second information layers, with main content beginning on the first information layer following a lead-in region and, potentially extending on the second information layer and followed at a predetermined position by enabling content and a lead-out region on the second information layer, wherein the optical shutter is located for blocking access to the enabling content of the second information layer, fill data being stored and extending between an end of the main content and a beginning to the enabling content.

7. The optical medium of claim 1 wherein the optical shutter has a transition region associated therewith, the transition region encompassing only a portion of the information layer that is not required to be accessed.

8. A conditional access system comprising:
a playback device for accessing an optical media having an optical shutter for conditionally blocking access to an enabling content region of the optical medium without blocking access to main content of the medium;
means for opening and/or closing the optical shutter with the optical medium being engaged by the playback device; and
means for determining authorization for accessing main content associated with the enabling content, the means for opening and/or closing being responsive to the means for determining thereby conditionally permitting access to the enabling content and consequently to the main content portion.

9. A method for conditionally accessing stored main content of an optical medium having an optical shutter for blocking access to an enabling content region of the optical medium without blocking access to the main content, comprising the steps of:
providing a playback device for accessing the optical media;
determining authorization for accessing main content associated with the enabling content;
opening and/or closing the optical shutter in response to the determined authorization; and
when the optical shutter is open following the determination, accessing the enabling content and consequently the associated main content.
